(19) United States
(12) Patent Application Publication
(10) Pub. No.: US 2010/0136956 A1
(43) Pub. Date: Jun. 3, 2010

(54) Real-time discovery and mutual screening of candidates for direct personal contact in user-designated vicinities

(76) Inventors: Alexander Drachev, Tempe, AZ (US); Victor Baidoon, Tempe, AZ (US); Michael Rozenman, Great Falls, VA (US)

Correspondence Address: Michael Rozenman, 307 Club View Drive, Great Falls, VA, 22066, US

(21) Appl. No.: 12/315,252

(22) Filed: Dec. 2, 2008

(51) Int. Cl. H04M 3/42

(52) U.S. Cl. 455/414.2

(57) ABSTRACT

A method for real-time discovery and mutual screening of candidates for direct personal contact in a vicinity, using electronic devices that can communicate with a central facility, and with each other. Each user individually sets one or more target vicinity, personal attributes, and screening criteria. A list of desirable and/or available candidates in his or her designated vicinity is delivered to each user's device. Users will be able to recognize the candidates from provided descriptions, and either modify their settings to adjust the lists, or send a request for contact to a selected available candidate. Each user can iterate, until their request is accepted, or they accept a request from another user. The method minimizes both the probability, and the embarrassment of rejection by means of mutual screening of the desirable available candidates.

### FIELD OF DISCLOSURE

The field of the invention, and the embodiments described herein, relate to the discovery and mutual screening of candidates for Direct Personal Contact among a plurality of people. These results are enabled by portable electronic devices, allowing their users to identify candidates in the designated vicinities, and then screen, review, and approach them to request a permission for personal contact.

### BACKGROUND

When people seek to expand their circle of contacts, there is a conflict between the need to be open for all desirable and available parties, and stay away from undesirable parties. The problem is especially acute if people who initially do not know each other, and located nearby, intend to make Direct Personal Contact, i.e., an interaction between two or more people not mediated by any other persons or systems.

Historically, ways to resolve this problem relied on external signs to indicate the status of the person exhibiting those signs. For examples, the Amish in Pennsylvania use the direction of the brim of a man's hat to indicate his availability, and allow women to detect (and avoid) married men. In many cultures, the appearance of girl's braids indicates her marital status. In the United States, gay communities in San Francisco are using the color and the position of a scarf to indicate that a person is seeking a partner with a particular sexual preference. A shortcoming of the overt signs is the public display of what is, at its core, a private message. Disclosure of a person's availability status would be safer and more useful if targeted only to desirable and available recipients, in a discreet manner, rather than broadcast to the world at large. The current invention is intended to create an effective, safe, and discreet iterative process, starting with each user screening other users using personalized criteria, and ending in an explicit permission for direct personal contact. This corrects the deficiencies of the prior art through the use of mutual screening, location-sensing technologies, and messaging.

The technology that is a subject of this disclosure will be of value for the companies and individuals seeking ways to engage their audience by providing new ways to use mobile devices for real-time applications, including social networking. Large social networks, instant messaging services, and mobile communications companies are the primary audience for the application of this technology.

### BRIEF SUMMARY OF THE INVENTION

The current disclosure provides a method that facilitates real-time discovery and mutual screening of candidates for Direct Personal Contact. This method is generally intended for people who do not know each other, but are located nearby. Each user individually designates a target vicinity where he wants to look for the candidates to be screened. All users carry electronic devices that can communicate with a central facility, and with other users' devices. The central facility stores each user's settings, including the target vicinity a user has designated, his demographic and personal data, screening criteria, and personal description (shown to other users). The central facility continually screens all users who are logged in, and creates two lists for each of them. The first list contains all desirable candidates in the designated vicinity, i.e., candidates that match this user's screening criteria. The second contain available candidates, i.e., those who find this user desirable. The lists of desirable and available candidates will be sent to each user's device for review, and in most cases each user will be able to recognize people on the list from their visual descriptions. Users will be able to modify their settings to adjust the lists, and to send a request for personal contact to any available candidate. They can continue to do so, until a selected candidate approves their request, or they will agree to a request from another user. A logical extension of the method allows users to designate multiple vicinities, with vicinity-specific screening criteria, and personal descriptions.

This method minimizes both the probability, and the embarrassment of rejection by means of mutual screening, that presents to each user the list of desirable candidates, and allows to select the best of the available ones. This method will be useful in the situations where Direct Personal Contact needs to be established between individuals who initially do not know each other, including dating, social mixers, professional and technical events, job fairs, and the like.

### SUMMARY OF THE PARTICULAR EMBODIMENTS OF THE INVENTION

This invention provides, among other things, multiple embodiments, which differ by the features of the communications system available to the electronic devices. In the SMS embodiment, devices use only text messaging over Short Message Service (SMS) protocol, or equivalent, which is available on most types of mobile phones. In the Rich Client embodiment, devices are running a client communicating to the central facility using an Internet protocol, including, but not limited to Simple Object Access Protocol (SOAP) or Extensible Messaging and Presence Protocol (XMPP), enabling more flexibility in handling of an individual session, and message exchange. Such a client would be running on a portable electronic devices in the environment such as Windows Mobile, Android, iPhone, Blackberry, Symbian, and the like.

### BRIEF DESCRIPTION OF THE DRAWINGS

The foregoing objects and advantages of this invention may be more readily understood by one skilled in the art with reference being had to the following detailed description of the illustrative embodiment thereof, taken in conjunction with the accompanying drawings, wherein the like elements are designated by identical reference numerals throughout several views, and in which:

FIG. 1 presents the functional block diagram, showing the main components of an illustrative embodiment, such as the central facility/server, the services, the database, and electronic devices connected to them through a communications network.

FIGS. 2, 3, and 4 present the illustrative embodiments of vicinity designation.

FIG. 5 presents the illustrative embodiment of the screening algorithm.

FIG. 6 refers to the SMS embodiment of the present invention, FIG. 7 refers to the. Rich Client embodiment. Each of these figures covers establishing a user session, communicating user data and personal screening criteria to the central facility, getting a response with a screened list of contacts, and sending a message to one of them.

FIG. 8 presents a functional diagram, illustrating the concept of mutual screening. It shows multiple electronic devices in the same vicinity, with session-specific information based on the users' personal settings.

### DETAILED DESCRIPTION

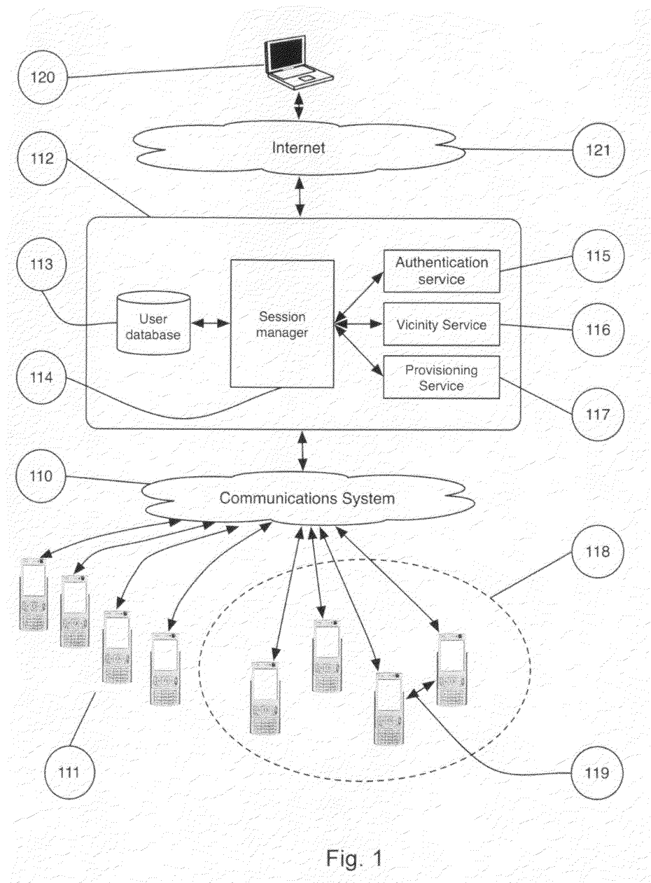

Referring now to the drawings and in particular to FIG. 1, there is shown an illustrative embodiment of this invention which uses the communications system 110 to connect a plurality of electronic devices 111, including, but not limited to, mobile phones, smart phones, personal digital assistants, computers, and other electronic devices, to the central facility 112, consisting of the user database 113, session manager 114, and several supporting services: authentication 115, vicinity 116, and provisioning service 117. In this illustrative embodiment, each of the electronic devices 111 has a unique identifier associated with a user, such as a mobile phone number, user name, or email address. The vicinity service 116 can always identify the plurality of devices within a given vicinity, denoted by a dotted line 118. Users of the electronic devices 111 review the screened lists of other available users, and can introduce themselves by initiating a chat session 119 with a selected candidate. It is contemplated that a user can also connect to the facility 112 using a computer 120 through the Internet 121.

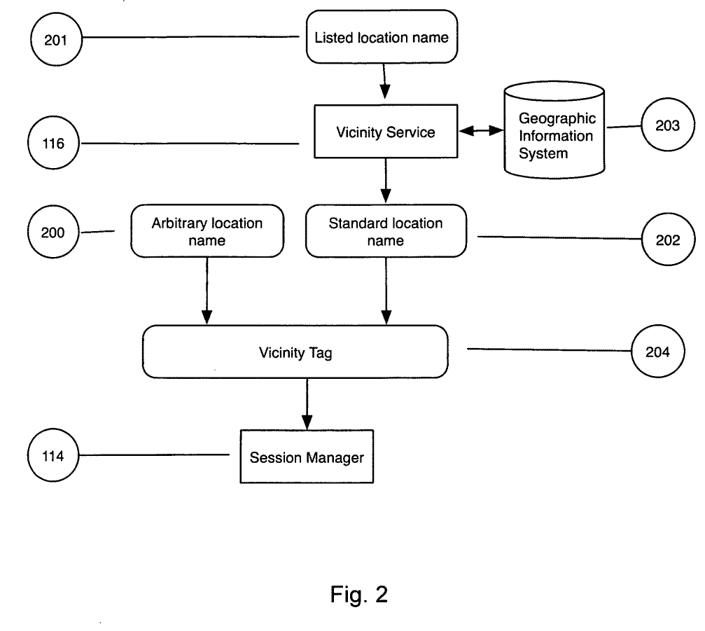

FIGS. 2, 3, and 4 detail the illustrative embodiments of the designation of vicinity where candidates for Direct Personal Contact are located.

In the embodiment illustrated by FIG. 2 a user specifies a vicinity by tag, so the vicinity includes all the users who describe their location using the same tag. A tag can be an arbitrary location name (“The PTA Conference Room”) 200, that goes directly to the session manager 114 as a tag 204. Alternatively, a user can specify a listed location name 201—a name resolvable to a standard location name 202 using a Geographic Information System 203 (“The Mall in Washington” resolves to “The Capital Mall, Washington, D.C.”). In the illustrative embodiment, the vicinity service 116 handles this location name resolution request, and passes the results to the session manager 114 as a vicinity tag 204. This way of vicinity designation does not rely on the ability of the electronic device to obtain or track its geo-spatial location.

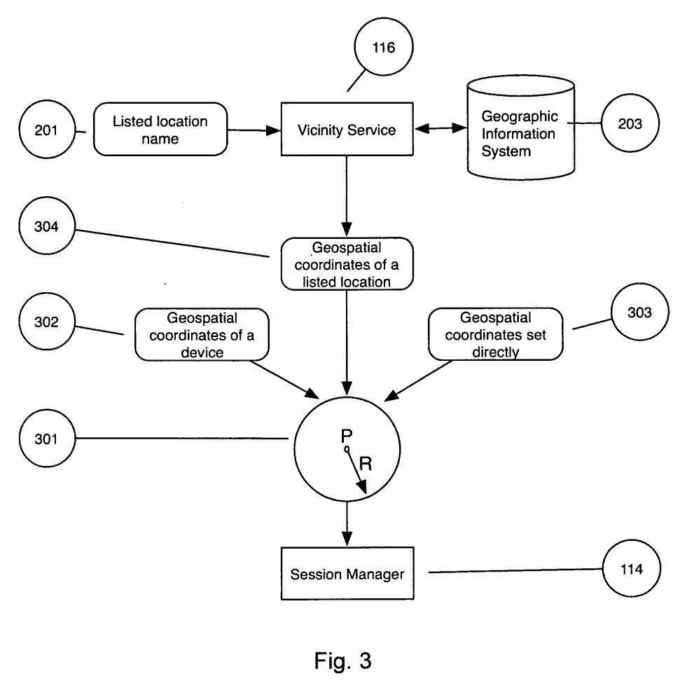

In the embodiment illustrated by FIG. 3 a vicinity is designated as a space within distance not exceeding R from a given reference point P, defined by geospatial coordinates 301. It is contemplated that various embodiments of the current invention will provide multiple methods of designating a reference point, including, but not limited to, the following: (a) the reference point is pegged to the tracked location 302 of the user's electronic device (detected through use of GPS, cell triangulation, WiFi, or similar functionality capable of determining the location of a device); (b) the reference point is directly defined through a set of geospatial coordinates 303; (c) the reference point is associated with a listed location name 201, and resolved to a static set of geo-spatial coordinates 304 via geocoding using a Geographic Information System 203, such as Google Maps or similar. In the latter method of this illustrative embodiment, vicinity service 116 gets the location resolution request from the session manager 114, handles the request, and returns the results.

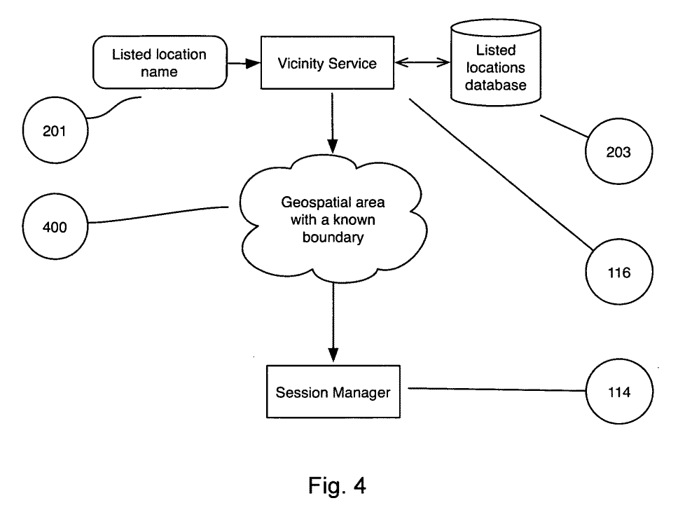

In the embodiment illustrated by FIG. 4 a vicinity is designated as a space within a given geo-spatial boundary 400. It is contemplated that the boundary will be associated with a named location 201, such as an attraction (“Central Park in New York City, N.Y.”), a business (“Hooters on Mill Street in Tempe, Ariz.”), or an object listed in a specialized database, such as “Area 51, Nevada”. In this illustrative embodiment, the vicinity service 116 gets the location name resolution request from the session manager 114, and either identifies the boundary 400 of the requested location, or fails. It is further contemplated that for any referenced electronic device, capable of obtaining its geo-spatial location using GPS or similarly enabling technology, a vicinity service determines if it is located within the identified boundary, or outside of this boundary, and returns the results.

The embodiments illustrated by FIGS. 3 and 4 rely on the ability of the user's electronic device to obtain its geo-spatial location data, and communicate it to the central server. It is contemplated that the implementations of the vicinity service will allow users to specify vicinity information using geo-spatial coordinates, a geo-spatial boundary, or a tag, and that geocoding can be used to convert tags into geo-spatial coordinates. This conversion allows the vicinity service to determine that users are located in the same vicinity, regardless of the way the vicinity is specified.

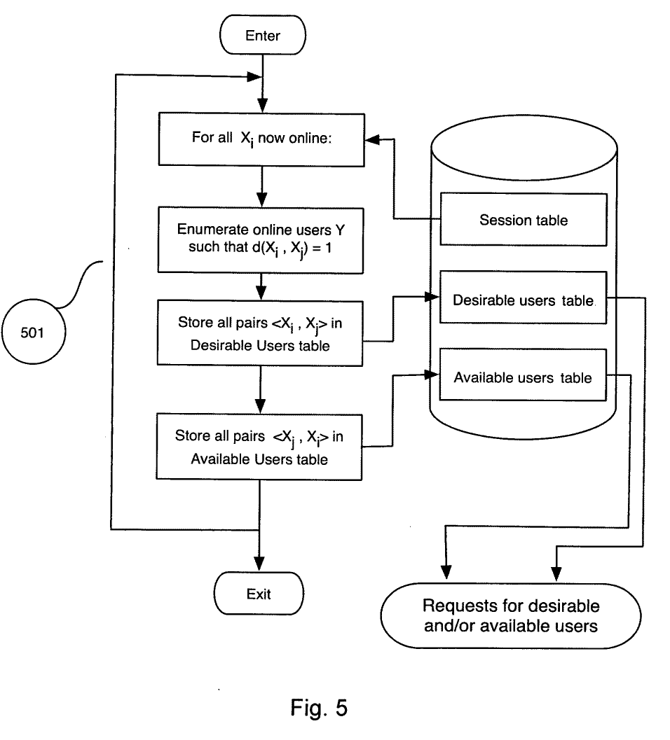

Referring now to FIG. 5, the illustrative embodiment of the screening algorithm used by the session manager 114 is based on the desirability matrix D and availability matrix A, defined as follows.

In this illustrative embodiment, X₁,X₂, . . . , X_{N} are the users of the illustrative system who are presently online, so the number of online users is N. We will say that user Xᵢ desires user Xⱼ, or that user Xⱼ is desirable for user Xᵢ, where, i,j=1, . . . , N, if the following two criteria are met:

(a) user Xⱼ is located in the vicinity designated by the user Xᵢ;

(b) user Xⱼ satisfies screening criteria established by the user Xᵢ.

The desirability matrix D is formed as follows:

d(Xᵢ,Xⱼ)={1, if user Xᵢ desires user Xⱼ; otherwise zero},

for all i,j=1, . . . , N, i≠j. Note that the relationship is not symmetrical, i.e., if user Xᵢ desires user Xⱼ, the reverse is not necessarily true. In this illustrative embodiment, the set of all users desirable to user Xᵢ, i ε {1, . . . , N}, is stored as the set of pairs

D(Xᵢ)={<Xᵢ,Xⱼ>|d(Xᵢ,Xⱼ)=1}

Similarly, for all Xᵢ, i ε {1, . . . , N}, the set of all users available to user Xᵢ is stored as the set of pairs

A(Xᵢ)={<Xᵢ,Xⱼ>|d(Xⱼ,Xᵢ)=1}

FIG. 5 illustrates the formation of two database tables: the desired users table where all sets D(Xᵢ) are stored, and the available users table, where all sets A(Xᵢ) are stored, for all users X₁, . . . , X_{N} who are currently online. Once these two tables are formed, all users who are desirable and available for a given user Xᵢ, i ε {1, . . . , N}, can be found by retrieving all pairs <Xᵢ,Xⱼ> from each of these tables. The loop 500 illustrates a method of keeping the desired users table and the available users table up to date by recalculating the matrixes D and A after a configurable period of time. Other methods of achieving the same goal include, but are not limited to, making corrective action when users come online, go offline, move to another location, designate a different vicinity, or modify their screening criteria.

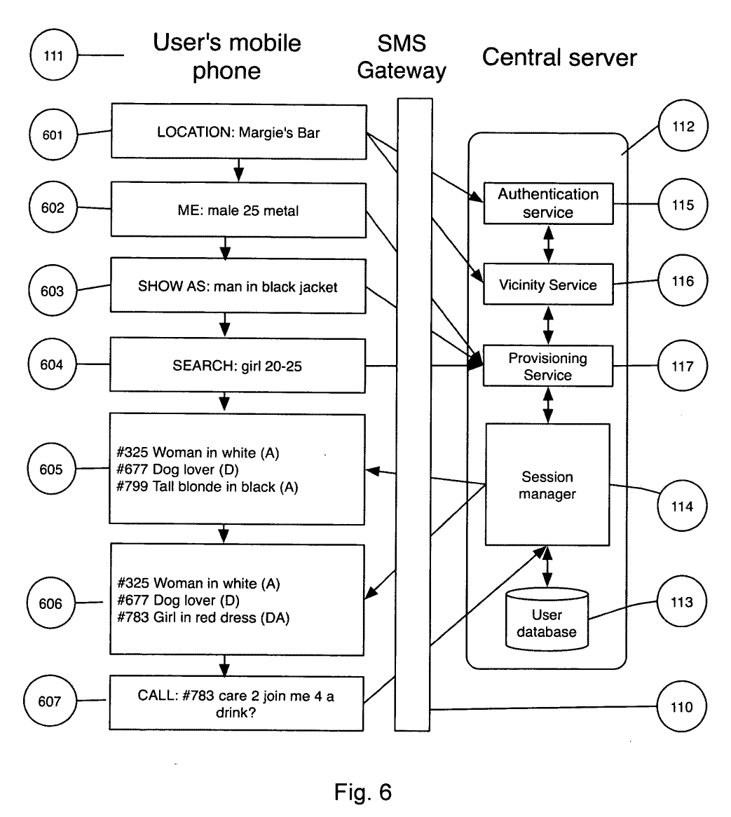

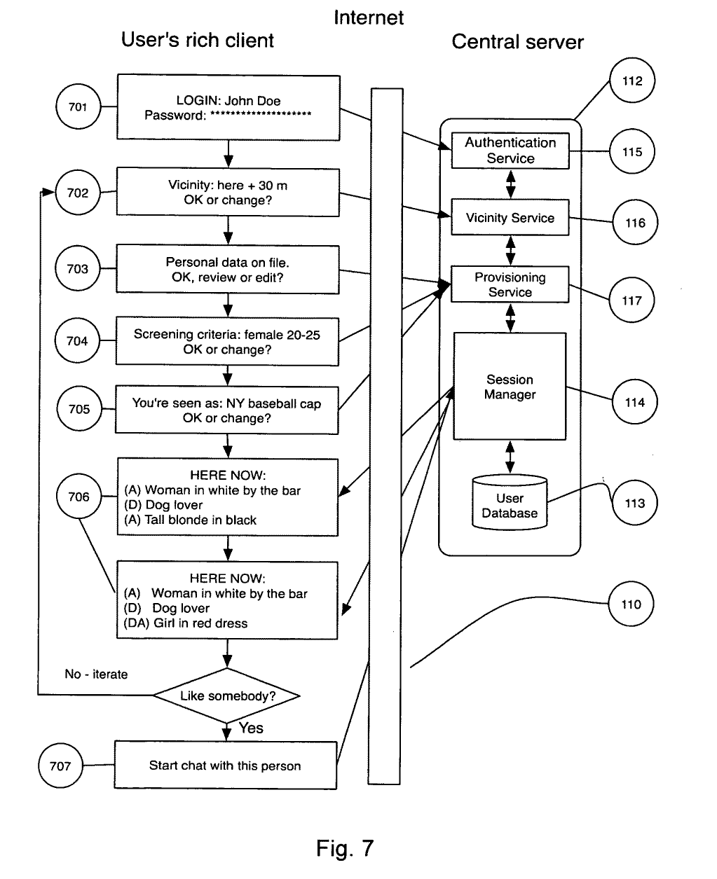

Referring now to FIG. 6, there is disclosed a functional chart illustrating the user session in an SMS embodiment of the present invention. A user of an SMS-enabled mobile phone established a session by sending an SMS message 601 to a particular SMS Gateway, which is the embodiment of the communications system 110 in this case. It is a function of this Gateway to interact with the central server 112, which uses the authentication service 115 to enable login, provisioning service 117 for setting the session parameters such as interests, screening criteria, and description, and vicinity service 116 for establishing current location of the device. Session manager 114 processes information from these services, performs the search of the user database, and returns the results to the device. Further, the vicinity service uses information acquired from the message 601 to designate “Margie's Bar” as the desired vicinity (see on FIG. 2). The user can optionally send several formatted SMS messages that can be used by the provisioning service 117 to set their personal attributes 602, their description information 603, and their screening criteria 604. Otherwise, values stored in the user profile are used for screening. In this illustrative embodiment, the user gets back a response with the list of candidates who are desirable, marked by a symbol (D), and/or available, marked by a symbol (A); candidates who are both desirable and available are marked with (DA) 605. If the user chooses not to act, the system may optionally send automatic updates of the list 606, until the user sends a message to one of them (identified by their numeric ID) with a proposal to make Direct Personal Contact 607, or terminates the process by signing off. Alternatively, the updates of the list 606 may be sent to the user on demand.

Referring now to FIG. 7, illustrating the Rich Client embodiment of the present invention, which also relies on the embodiment of the vicinity service illustrated by FIG. 3. A user starts a session by logging in 701. Once authenticated by the authentication service 115, the client prompts the user to verify their vicinity setting 702. In this example, the user is prompted to confirm the designated vicinity as the space within 30 meters of the device (as illustrated by FIG. 3). Assuming the user confirms, the control is passed to the provisioning service, which prompts the user to confirm their demographic data 703. At this stage, the provisioning service presents the option of confirming the data on file without a review, initiating a review, or going straight to editing the demographic data on file. After the data is confirmed (with or without edit), the provisioning service presents the option to review the screening criteria 704, or edit them. After they are confirmed (with or without edit), the provisioning service presents the option to review the user's personal description information 705, or edit it. After the data is confirmed (with or without edit), the session manager supplies the Client with the list of candidates who are desirable, marked by a symbol (D), and/or available, marked by a symbol (A); candidates who are both desirable and available are marked with (DA) 706. The list is passed to the requesting user for a review. The user can iterate through steps 702 through 706, or start a chat with a selected candidate 707. If the user chooses not to act, the system will automatically send the updates to the list.

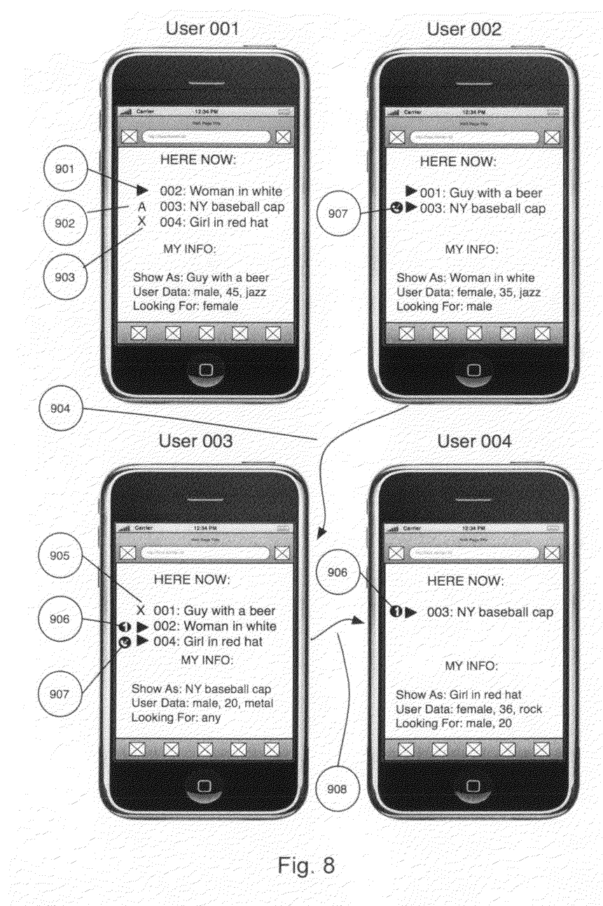

Referring now to FIG. 8, relating to the Rich Client embodiment of the present invention, there is disclosed a visualization of the mutual screening process between multiple users looking for a dating partner. For illustrative purposes we will assume that each of the four users is within each other's designated vicinity, and there are no other users in any of these vicinities. The summary of user data, screening criteria, and personal descriptions are listed in the Table 1.

In this illustrative embodiment, users' devices list all desirable and/or available users. In this example, the electronic devices of four users on FIG. 8 show the following information. User 001 will see the descriptions of users 002, 003, and 004, showing 002 as desirable and available, 003 as available but not desirable, and user 004 as desirable, but unavailable, because he does not satisfy the screening criteria of user 004. User 002 will see users 001 and 003 as desirable and available. User 003 will see users 002 and 004 as desirable and available, user 001 as desirable, but unavailable, because he does not satisfy the screening criteria of user 001. User 004 will see only user 003 as desirable and available; other users do not satisfy her screening criteria.

TABLE 1

| | | Screening | Personal | | Available |
|---|---|---|---|---|---|
| User | User Data | Criteria | description | Desirable Users | Users |
| 001 | Male, 45, | Female | Guy with | 002, 004 | 002, 003 |
| | jazz | | a beer | | |
| 002 | Female, | Male | Woman | 001, 003 | 001, 003 |
| | 35, jazz | | in white | | |
| 003 | Male, 20, | Any | NY baseball | 001, 002, 004 | 002, 004 |
| | metal | | cap | | |
| 004 | Female, | Male, 20 | Girl in | 003 | 003 |
| | 36, rock | | red hat | | |

In the illustrative embodiment shown on FIG. 8, small icons to the left of the user's description denote desirability, availability, and communication status. Icon 901 indicates “desirable, and available”; icon 902—“not desirable, but available”; icon 903 indicates “desirable, but unavailable”, icon 906 indicates the number of messages from that party waiting, icon 907 indicates “a message has been sent to this user”. In the illustrative example on FIG. 8, on the device used by 003 there is an icon 905 against user 001 indicating “desirable, but unavailable”, an icon 906 against user 002 indicating “1 message from this user is waiting”, and an icon 907 against user 003 indicating “message has been sent to this user”. Consequently, user 004 sees “1 message from this user is waiting” indication 906 from user 003, and user 002 sees a “message has been sent to this user” indication 907 against user 003. It is contemplated that selecting a particular user on this screen will initiate a lookup, to find more detailed information available about this user. From there one can optionally proceed to chat with this user. In the example illustrated by FIG. 8, user 002 has sent a request for contact 904 to user 003, and user 003 has sent a request for contact 908 to user 004.

1. A method for real-time discovery and mutual screening of candidates for Direct Personal Contact, i.e., an interaction between two or more people not mediated by any other persons or systems, comprising: (a) a plurality of electronic devices communicating with a central facility and with each other; (b) an interface on these devices, allowing users to enter and edit personal attributes, designate a target vicinity, and set their personal description in text and/or media; (c) a facility to discover devices located in each of the vicinities designated by the users; (d) a facility for each user to set and edit screening criteria based on the attributes of other users; (e) a facility to enumerate, for each user, all desirable candidates in his designated vicinity, as users matching his screening criteria; (f) a facility to enumerate all candidates available to a given user, as all users to whom this user is desirable; (g) an interface on the devices that lists to each user who is desirable, and who is available; (h) a facility to notify user about changes in their lists of desirable and available users; (i) a facility and user interface to initiate a private chat session to request and receive pre-approval for Direct Personal Contact with an available user.

2. The method of claim 1, wherein each user can designate multiple vicinities.

3. The method of claim 1, wherein users can designate vicinities using tags.

4. The method of claim 3, wherein a tag is an arbitrary text label.

5. The method of claim 3, wherein a tag is the name of a location.

6. The method of claim 1, wherein users can designate vicinities as areas within a given distance from a reference point with specific geo-spatial coordinates.

7. The method of claim 6, wherein a reference point is the current location of the user's electronic device.

8. The method of claim 6, wherein a reference point is a named or tagged location with geo-spatial coordinates obtained using geocoding, making it possible to determine that users are in the same vicinity, regardless of the method used to specify it.

9. The method of claim 1, wherein users can designate vicinities as named areas with established geo-spatial boundaries.

10. The method of claim 1, wherein the user's personal data attributes contain demographic information and physical characteristics, including, but not limited to age, gender, height, hair color, preferred languages, interests, and other commonly used attributes.

11. The method of claim 1, wherein personal screening criteria can be an arbitrary logical combination of the restrictions on the available attributes.

12. The method of claim 1, wherein a user can define a plurality of his or her personal descriptions, including a visual description sufficient to recognize them, to be used conditionally, based on the attributes, or the identity of the reviewing user.

13. The method of claim 2, wherein each user can independently set and edit screening criteria and personal data attributes for each of the vicinities he designates.

14. The method of claim 2, wherein a user can define a plurality of his or her personal descriptions, including a visual description sufficient to recognize them, to be used conditionally, based on the vicinity.
